(19) United States
(12) Patent Application Publication
(10) Pub. No.: US 2006/0029108 A1
(43) Pub. Date: Feb. 9, 2006

(54) Digital device, transcoder, and data transmitting method

(75) Inventors: Hiroyasu Miura, Fukaya-shi (JP); Takashi Kokubo, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/119,828

(22) Filed: May 3, 2005

(30) Foreign Application Priority Data
May 31, 2004 (JP) 2004-161423

(51) Int. Cl. H04J 3/12

(52) U.S. Cl. 370/527

(57) ABSTRACT

A data transmitting method of transmitting encoded data of a first signal format from a transmitting device to a receiving device via a transcoder includes obtaining, for example, information representing decoding and encoding processes supported by the transcoder, and information representing that the signal supported by the receiving device is encoded data of the second signal format, controlling the connection between the transmitting device and the transcoder, and between the transcoder and the receiving device, selecting a decoding process corresponding to the encoded data of the first signal format, and an encoding process corresponding to the encoded data of the second signal format, decoding the encoded data of the first signal format by the selected decoding process, encoding the decoded data by the selected encoding process, and transmitting the data to the receiving device.

### CROSS-REFERENCE TO RELATED APPLICATIONS

This application is based upon and claims the benefit of priority from prior Japanese Patent Application No. 2004-161423, filed May 31, 2004, the entire contents of which are incorporated herein by reference.

### BACKGROUND OF THE INVENTION

1. Field of the Invention

The present invention relates to a digital device which is connected to a network, and transmits data to a partner device on this network via a transcoder on the network. The present invention also relates to a transcoder which is connected to a network, receives encoded data from a transmitting device on this network, converts this encoded data into other encoded data, and transmits the converted encoded data to a receiving device on the network. The present invention also relates to a data transmitting method of transmitting encoded data output from a transmitting device on a network, to a receiving device on this network via a transcoder on the network.

2. Description of the Related Art

Recently, various digital devices have been developed and prevailed. These various digital devices can be connected to a network, and transmit/receive data to/from each other via the network. However, in some cases, the signal format of data to be output from a given digital device does not correspond to that of data to be received by another digital device. That is, in an environment wherein the various digital devices are connected to the network, in some cases, data having a signal format and output from a given digital device cannot be directly input to another digital device.

In order to cope with the above problem, for example, in FIG. 1 of Jpn. Pat. Appln. KOKAI Publication No. 2003-264573, a technique of converting MPEG2-TS compressed data output from a digital device on an MPEG2-TS network into DV compressed data, and then transmitting the DV compressed data to a digital device on a DV network is proposed.

However, in the technique of the above reference, the MPEG2-TS network and the DV network are independently built, and connected via a gateway including the transcoder. Therefore, only the MPEG2-TS digital signal can be transmitted on the MPEG2-TS network side, and only the DV digital signal can be transmitted on the DV network side, respectively. In this arrangement, data communication is allowed for only networks connected via a gateway, so that versatility is low.

### BRIEF SUMMARY OF THE INVENTION

In an example of the present invention, a digital device which transmits data to a partner device via a transcoder which converts encoded data into encoded data of another format, comprises an output unit configured to output encoded data of a first signal format to the transcoder, an obtaining unit configured to obtain transcoder information representing signal formats decodable and encodable by the transcoder, and partner device information representing a second signal format to which the partner device can be applied, and a controller configured to transmit, to the transcoder, a decoding selection signal which causes the transcoder to select a decoding process corresponding to the encoded data of the first signal format, and an encoding selection signal which causes the transcoder to select an encoding process corresponding to encoded data of the second signal format, on the basis of the transcoder information and the partner device information.

In an example of the present invention, a transcoder which receives encoded data from a transmitting device, converts the encoded data into other encoded data, and transmits the converted encoded data to a receiving device, comprises a receiving unit configured to receive encoded data of a first signal format from the transmitting device, a first decoding unit configured to decode the encoded data of the first signal format, a first encoding unit configured to encode decoded data decoded by the first decoding unit into encoded data of a second signal format, a notification unit configured to notify the transmitting device of transcoder information representing the first signal format decodable by the first decoding unit, and the second signal format encodable by the first encoding unit, a decoding/encoding controller configured to receive, from the transmitting device, a decoding selection signal corresponding to the encoded data of the first signal format, and an encoding selection signal corresponding to the encoded data of the second signal format, cause the first decoding unit to decode the encoded data of the first signal format received by the receiving unit, and cause the first encoding unit to encode the decoded data into the encoded data of the second signal format, and a transmitting unit configured to transmit the encoded data of the second signal format to a predetermined receiving device on the basis of information representing a destination of the encoded data of the second signal format from the transmitting device.

In an example of the present invention, a data transmitting method of transmitting encoded data of a first signal format output from a transmitting device, to a receiving device via a transcoder, comprises obtaining transcoder information representing signal formats decodable and encodable by the transcoder and device information representing a second signal format to which the receiving device can be applied, selecting a decoding process performed by the transcoder which corresponds to the encoded data of the first signal format, selecting an encoding process performed by the transcoder which corresponds to the encoded data of the second signal format, decoding the encoded data of the first signal format output from the transmitting device, by the selected decoding process, encoding the decoded data into encoded data of the second signal format, by the selected encoding process, and transmitting the encoded data of the second signal format to the receiving device via the transcoder.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing an example of an IEEE 1394 network to which a digital device and transcoder of this invention are applied;

FIG. 2 is a block diagram showing an example of the functional structure of a shared transcoder shown in FIG. 1;

FIG. 3 is a block diagram showing an example of the physical structure of the shared transcoder shown in FIG. 1;

FIG. 4 is a block diagram showing an example of the physical structure of the digital device such as a DTV, DVHS, DVC, or AV-HDD shown in FIG. 1;

FIG. 5 is a flowchart showing an example of a data transmitting process of transcoding and sending a digital signal such as video, audio, or data from a given device to another device; and

FIG. 6 is a table showing an example of information notified from a device A to the shared transcoder.

### DETAILED DESCRIPTION OF THE INVENTION

An embodiment of the present invention will be described below with reference to accompanying drawings.

FIG. 1 is a block diagram showing an example of an IEEE 1394 network to which a digital device and transcoder of this invention are applied. As shown in FIG. 1, an IEEE 1394 bus connects a digital TV (DTV) 101, digital VHS (DVHS) 102, digital video camera (DVC) 103, AV-HDD 104, shared transcoder 105, PDA 106, and the like.

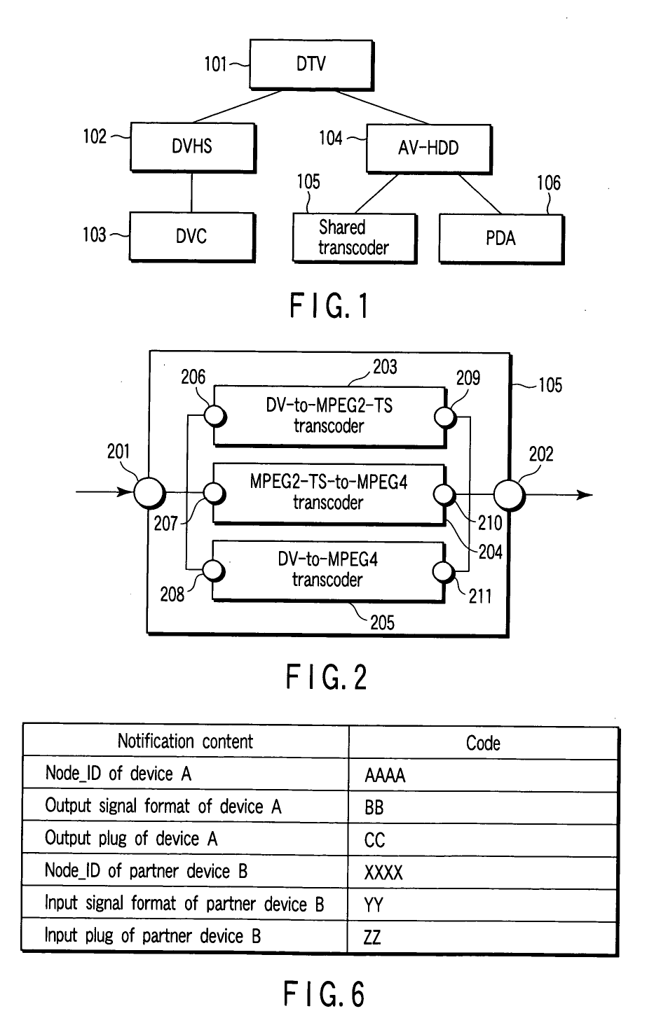

FIG. 2 is a block diagram showing the functional structure of the shared transcoder 105 shown in FIG. 1. As shown in FIG. 2, the shared transcoder 105 includes functional blocks such as a DV-to-MPEG2-TS transcoder 203, MPEG2-TS-to-MPEG4 transcoder 204, and DV-to-MPEG4 transcoder 205. Also, the shared transcoder 105 includes an input plug 201 and output plug 202. The DV-to-MPEG2-TS transcoder 203 includes an input plug (destination plug) 206 and output plug (source plug) 209, the MPEG2-TS-to-MPEG4 transcoder 204 includes an input plug (destination plug) 207 and output plug (source plug) 210, and the DV-to-MPEG4 transcoder 205 includes an input plug (destination plug) 208 and output plug (source plug) 211.

With reference to the 1394TA AV/C Document 1999026 “AV/C Digital Interface Command Set General Specification Version 4.0” [1], the shared transcoder 105 can be defined as a unit, and each of the DV-to-MPEG2-TS transcoder 203, MPEG2-TS-to-MPEG4 transcoder 204, and DV-to-MPEG4 transcoder 205 can be defined as a subunit.

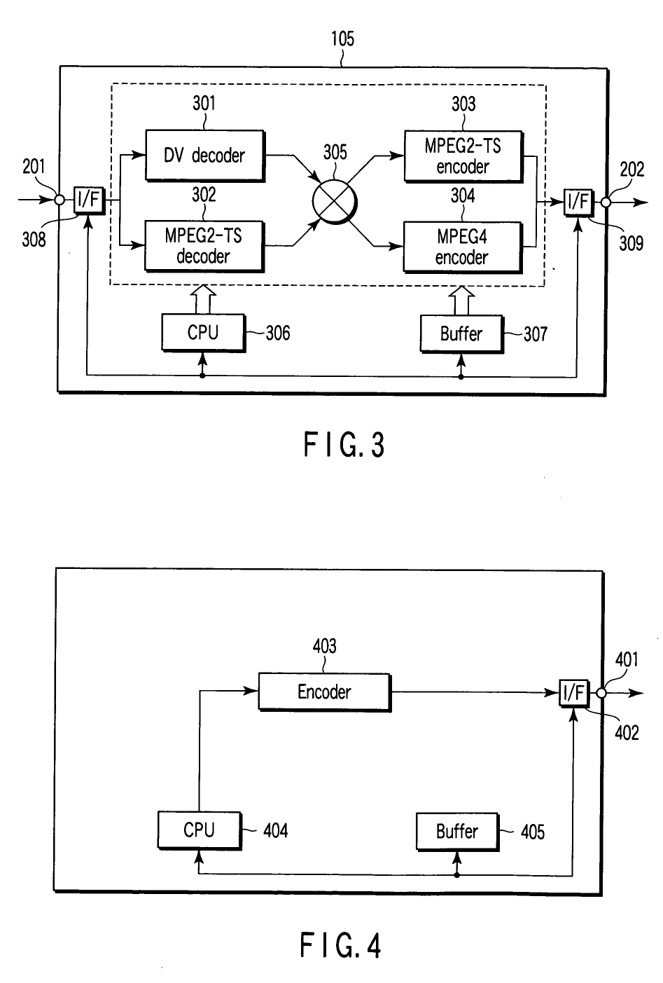

FIG. 3 is a block diagram showing the physical structure of the shared transcoder 105. As shown in FIG. 3, the shared transcoder 105 includes, e.g., a DV decoder 301, MPEG2-TS decoder 302, MPEG2-TS encoder 303, MPEG4 encoder 304, and switch 305. For example, when a DV signal is to be transcoded into an MPEG2-TS signal, the DV signal is decoded by the DV decoder 301, and then compressed and converted into the MPEG2-TS signal by the MPEG2-TS encoder 303.

The shared transcoder 105 also includes the selection unit 305, a CPU 306, a buffer 307, and network interfaces 308 and 309.

FIG. 4 is a block diagram showing the physical structure of the digital device such as the DTV 101, DVHS 102, DVC 103, or AV-HDD 104 shown in FIG. 1. As shown in FIG. 4, the digital device includes, e.g., an output plug 401, network interface 402, encoder 403, CPU 404, and buffer 405.

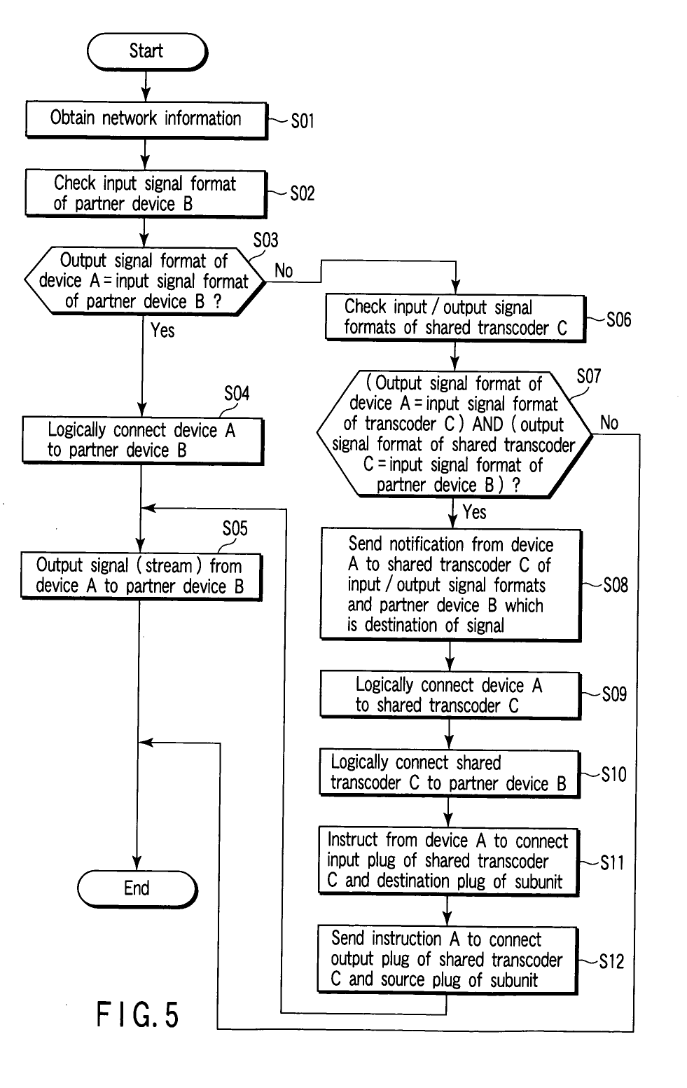

FIG. 5 is a flowchart showing a data transmitting process of transcoding and sending a digital signal such as video, audio, or data from a given device to another device. For example, FIG. 5 shows the case wherein DVC data is converted into MPEG2-TS data, and the converted data is sent from the DVC 103 to the DTV 101 via the shared transcoder 105. Also, FIG. 5 shows the case wherein the MPEG2-TS data is converted into MPEG4 data, and the converted data is sent from the DVHS 102 to the PDA 106 via the shared transcoder 105.

First, a device A (transmitting device), i.e., the CPU 404, which is to send a digital signal obtains network information and stores the obtained network information in the buffer 405, via the network interface 402 (step S01). This network information represents the number of devices on the network, the type of device set in the Node_ID determined by the algorithm of the IEEE 1394-1995 Standard (“IEEE Standard for a High Performance Serial Bus”, IEEE Std. 1394-1995), the number of the input plugs and input signal format of each of the devices, the number of the output plugs and output signal format of each of the devices, and the like.

Next, device A (CPU 404) checks the input plug and input signal format of a partner device B (receiving device) which is the destination of the digital signal (step S02). That is, via the network interface 402, device A obtains the partner device information which represents the signal format with which partner device B can cope, and stores the obtained information in the buffer 405.

For example, device A (CPU 404) outputs, from the output plug 401, the output signal format data encoded by the encoder 403. When the output signal format of device A matches the input signal format of partner device B (YES in step S03), device A (CPU 404) can logically connects device A serving as an output side to partner device B serving as an input side (step S04), and transmit the digital signal (stream) to partner device B without transcoding the data (step S05).

However, when the output signal format of device A is different from the input signal format of partner device B (NO in step S03), device A (CPU 404) cannot transmit the digital signal (stream) to partner device B without transcoding the data. Hence, device A (CPU 404) checks the input plug 201 and input signal format, and the output plug 202 and output signal format of a shared transcoder C (=shared transcoder 105) (step S06). That is, device A (CPU 404) obtains transcoder information which represents the plurality of kinds of signal formats decodable and encodable by transcoder C, and stores the obtained information in the buffer 405.

Assume that the plurality of input signal formats supported by shared transcoder C include the output signal format of device A (i.e., the plurality of logical input plugs of shared transcoder C include the input signal format matching the output signal format of device A), and the plurality of output signal formats supported by shared transcoder C include the input signal format of partner device B (i.e., the plurality of logical output plugs of shared transcoder C include the output signal format matching the input signal format of partner device B) (YES in step S07). Device A (CPU 404) notifies shared transcoder C of partner device B which is the destination of the input/output signal formats and the signal (step S08).

As shown in FIG. 6, the information notified from device A to shared transcoder C represents the Node_ID of device A, the output signal format of device A, the output plug of device A, the Node_ID of partner device B, the input signal format of partner device B, the input plug of partner device B, and the like. With reference to 1394TA AV/C Document 1999026 “AV/C Digital Interface Command Set General Specification Version 4.0” [1], the input/output plugs can be defined. Also, the signal format can use an FMT value described in “IEC 61883, Digital Interface for Consumer Electronic Audio/Video Equipment”. Note that although the FMT values of the DV and MPEG2-TS signal formats are defined, the FMT value of the MPEG4 signal format is not defined. Therefore, a free (vender unique) value can be provisionally used.

On the basis of the information notified from device A, shared transcoder C determines which decoders and encoders are to be used, and connects the determined decoder and encoder in transcoder C. For example, when the output signal format of device A (i.e., the input signal format of shared transcoder C) is the DV format, and the input signal format of partner device B (i.e., the output signal format of shared transcoder C) is the MPEG2-TS format, the DV decoder 301 and the MPEG2-TS encoder 303 are selected and connected to each other.

Next, device A (CPU 404) logically connects device A serving as the output side to shared transcoder C serving as the input side (step S09), and then logically connects shared transcoder C serving as the output side to partner device B serving as the input side (step S10).

Also, on the basis of the instruction from device A to shared transcoder C, device A (CPU 404) controls the connection between the input plug 201 of shared transcoder C and the destination plug (one of the input plugs 206, 207, and 208) of the subunits (transcoders 203, 204, and 205) (step S11).

Likely, device A (CPU 404) controls the connection between the output plug 202 of shared transcoder C and the source plug (one of the output plugs 209, 210, and 211) of the subunits (transcoders 203, 204, and 205) (step S12).

As described above, after the completion of the connections, device A (CPU 404) controls to transcode and transmit the digital signal to partner device B via shared transcoder C (step S05). With this process, partner device B receives the signal converted into the signal format supported by partner device B. Hence, the process (e.g., video display, speech output, or printing process) of the input signal can be performed.

Alternatively, assume that the plurality of input signal formats supported by shared transcoder C do not match the output signal format of device A, and the plurality of the output signal formats supported by shared transcoder C do not match the input signal format of partner device B (NO in step S07). Device A (CPU 404) cannot transmit the digital signal to partner device B. In this case, for example, device A notifies a user that the digital signal cannot be transmitted to partner device B.

The processes of above-described shared transcoder 105 will be summarized as follows.

The shared transcoder 105 is connected to the network on which the transmitting and receiving devices for respectively transmitting and receiving the digital signal.

Via the network interface 308, the shared transcoder 105 (CPU 306) receives control information which includes the input signal format (output signal format of the transmitting device) and output signal format (input signal format of the receiving device) from the transmitting device for transmitting the digital signal, and stores the received control information in the buffer 307. On the basis of the received control information, the shared transcoder 105 (CPU 306) selects the decoder 301 or 302, and the encoder 303 or 304 in the shared transcoder 105 by the selection unit 305, and connects the selected decoder and encoder in the shared transcoder 105.

The shared transcoder 105 (CPU 306) notifies an external device (transmitting device) of the types of internal transcoders (DV-to-MPEG2-TS transcoder 203, MPEG2-TS-to-MPEG4 transcoder 204, and DV-to-MPEG4 transcoder 205), in the subunit format via the network interface 308.

The transcoder subunits such as DV-to-MPEG2-TS transcoder 203, MPEG2-TS-to-MPEG4 transcoder 204, and DV-to-MPEG4 transcoder 205 included in the shared transcoder 105 are grouped into decoder subunits such as the DV decoder 301 and MPEG2-TS decoder 302, and encoder subunits such as the MPEG2-TS encoder 303 and MPEG4 encoder 304. With this arrangement, various transcoders can be arranged efficiently.

Not only three transcoder subunits in FIG. 2 but also N transcoder subunits can be built into the shared transcoder 105 as needed.

The input plug (destination plug) of each of the decoders included in the shared transcoder 105 may be connected to the plurality of logical input plugs of the shared transcoder 105 in advance. In this case, step S11 in FIG. 5 can be omitted.

Also, the output plug (source plug) of each of the encoders included in the shared transcoder 105 may be connected to the plurality of logical output plugs of the shared transcoder 105 in advance. In this case, step S12 in FIG. 5 can be omitted.

As described above, in the present invention, even if the transcoder is not built into each device on the network, the signal output from a given device can be received by another device which does not support the signal format output from the given device as long as the shared transcoder is connected to the network, by using this shared transcoder. Therefore, digital signals of substantially different signal formats can be transmitted/received in the single network. Also, the plurality of different digital signal formats can be transcoded simultaneously.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A digital device which transmits data to a partner device via a transcoder which converts encoded data into encoded data of another format, comprising:
an output unit configured to output encoded data of a first signal format to the transcoder;
an obtaining unit configured to obtain transcoder information representing signal formats decodable and encodable by the transcoder, and partner device information representing a second signal format to which the partner device can be applied; and
a controller configured to transmit, to the transcoder, a decoding selection signal which causes the transcoder to select a decoding process corresponding to the encoded data of the first signal format, and an encoding selection signal which causes the transcoder to select an encoding process corresponding to encoded data of the second signal format, on the basis of the transcoder information and the partner device information.

2. A device according to claim 1, wherein the controller controls a data transmitting process by detecting a difference between the first signal format and the second signal format on the basis of the partner device information, detecting, on the basis of the transcoder information, that the first signal format matches an input signal format decodable by the transcoder, and detecting, on the basis of the transcoder information and the partner device information, that the second signal format matches an output signal format encodable by the transcoder.

3. A device according to claim 2, wherein the controller controls a connection between the digital device serving as an output side and the transcoder serving as an input side, and controls a connection between the transcoder serving as an output side and the partner device serving as an input side.

4. A transcoder which receives encoded data from a transmitting device, converts the encoded data into encoded data of another format, and transmits the converted encoded data to a receiving device, comprising:
a receiving unit configured to receive encoded data of a first signal format from the transmitting device;
a first decoding unit configured to decode the encoded data of the first signal format;
a first encoding unit configured to encode decoded data decoded by the first decoding unit into encoded data of a second signal format;
a notification unit configured to notify the transmitting device of transcoder information representing the first signal format decodable by the first decoding unit, and the second signal format encodable by the first encoding unit;
a decoding/encoding controller configured to receive, from the transmitting device, a decoding selection signal corresponding to the encoded data of the first signal format, and an encoding selection signal corresponding to the encoded data of the second signal format, cause the first decoding unit to decode the encoded data of the first signal format received by the receiving unit, and cause the first encoding unit to encode the decoded data into the encoded data of the second signal format; and
a transmitting unit configured to transmit the encoded data of the second signal format to a predetermined receiving device on the basis of information representing a destination of the encoded data of the second signal format from the transmitting device.

5. A transcoder according to claim 4, further comprising:
a decoding unit configured to include the first decoding unit, and a second decoding unit which is different from the first decoding unit;
an encoding unit configured to include the first encoding unit, and a second encoding unit which is different from the first encoding unit; and
a connection unit configured to, in correspondence with the selection signal, select the first decoding unit from the decoding unit on the basis of the selection signal of the decoding process, select the first encoding unit from the encoding unit on the basis of the selection signal of the encoding process, and connect the first decoding unit and the first encoding unit.

6. A data transmitting method of transmitting encoded data of a first signal format output from a transmitting device, to a receiving device via a transcoder, comprising:
obtaining transcoder information representing signal formats decodable and encodable by the transcoder and device information representing a second signal format to which the receiving device can be applied;
selecting a decoding process performed by the transcoder which corresponds to the encoded data of the first signal format;
selecting an encoding process performed by the transcoder which corresponds to the encoded data of the second signal format;
decoding the encoded data of the first signal format output from the transmitting device, by the selected decoding process;
encoding the decoded data into encoded data of the second signal format, by the selected encoding process; and
transmitting the encoded data of the second signal format to the receiving device via the transcoder.

7. A method according to claim 6, further comprising performing a data transmitting process by detecting a difference between the first signal format and the second signal format on the basis of the partner device information, detecting, on the basis of the transcoder information, that the first signal format matches an input signal format decodable by the transcoder, and detecting, on the basis of the transcoder information and the partner device information, that the second signal format matches an output signal format encodable by the transcoder.

8. A method according to claim 7, further comprising controlling a connection between the transmitting device serving as an output side and the transcoder serving as an input side, and controlling a connection between the transcoder serving as an output side and the receiving device serving as an input side.
